(19) United States
(12) Patent Application Publication
(10) Pub. No.: US 2006/0093767 A1
(43) Pub. Date: May 4, 2006

(54) Flexible coated article and method of making the same

(75) Inventor: Robert Allen Janssen, Alpharetta, GA (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/978,343

(22) Filed: Nov. 1, 2004

(51) Int. Cl. B32B 27/32

(52) U.S. Cl. 428/35.7; 428/35.2

(57) ABSTRACT

Disclosed herein is an elastomeric article having a donning layer coating that increases the ease of donning such an article. The donning layer is a copolymer material made of monomers that are incompatible with one another. When the copolymer dries on the surface of the elastomeric article the incompatible monomers phase out into separate domains and provide the elastomeric article with a hard and textured surface.

### BACKGROUND

Tightly fitting elastomeric articles, such as surgical and examination gloves, may be difficult to don due to clinging or friction between the surface of the article and that of the skin of the wearer. The problem of donning becomes greater when the skin of the wearer is damp. This is primarily the case with surgical gloves where the surgeon prepares his hands prior to insertion into the glove by scrubbing them and, as often is the case, performing only a fast, incomplete drying. Once partially dried, the surgeon will usually wave the hands to evaporate additional moisture, put on a surgical gown and then don the gloves with assistance.

Natural latex gloves are tacky and have a high coefficient of friction. This does not allow for the easy introduction of a hand into the glove. Therefore, some sort of surface treatment is required on the inner surface of the glove to facilitate donning. Traditionally, powdered lubricants have been applied to the inside surface of the glove to reduce friction between the skin and the glove. Unfortunately, the use of powdered lubricants may not be appropriate for specific situations, such as the case of surgical gloves. Specifically, if some of the powder escapes from the inside of the glove into the surgical environment, as for example if the glove is torn during the surgery, the powder may enter the surgical wound and cause further complications for the patient.

As a result, other solutions have been developed to aid in the donning of elastomeric gloves. Polymeric lubricant coatings have been developed to modify the interior surface of the gloves in an effort to provide a safe and effective donning for medical practitioners. To date, the surface modification coating that has had the best success and that is most accepted is a hydrogel polymeric coating.

U.S. Pat. Nos. 4,548,844 and 4,575,476. both to Podell et al., and U.S. Pat. No. 4,499,154 to James et al. all disclose gloves with a continuous inner layer of such hydrogel polymers. All discuss specific concentrations of various combinations of 2-hydroxyethyl methacrylate (HEMA), 2-ethylhexyl acrylate (HMA), and methacrylic acid (MAA) copolymerized to form a continuous film on the glove after coating.

Such a hydrogel polymeric coating requires crosslinking of the hydrogel polymer to both attach the polymeric coating to the natural latex of the glove, such that the coating does not separate from the latex when the glove is stretched, and to prevent the hydrophilic hydrogel polymer from dissolving upon rehydration during subsequent processing during manufacture. This curing requires a formaldehyde-based crosslinking agent and a catalyst, such as a para-toluene sulfonic acid catalyst. These formaldehyde-based crosslinking agents and toluene-based catalysts may present waste disposal problems due to their toxicity and if not properly and completely washed from the finished gloves may cause undesired interaction with a wearer's hand.

Other problems have been encountered with these systems. For instance, highly hydrophilic coatings absorb a great deal of water, causing substantial volume changes in the coating during hydration and drying. This may lead to delamination and peeling of the coating from the glove surface. Additionally, highly hydrophilic polymers are often quite rigid in the dry state. This may lead to cracks forming in the coating, which may also lead to delamination of the coating from the surface of the elastomeric article.

Additionally, gloves with a hydrogel polymer donning coating require chlorination and a lubricant coating to enable ease in donning. Chlorination is effective in reducing the tackiness of the surface, but it is an expensive step that requires the use of a hazardous chemical (chlorine) in the manufacturing process. It also has the shortcoming of reducing the shelf life of the rubber article. A lubricant, such as a silicone polymer, is also required to aid in donning of the article. Such additional materials and processing steps are additional costs to the manufacturing of such articles.

Another method of improving the ease of glove donning has been the addition of hard particles to the donning coating of the gloves. These hard particles give the donning layer a textured surface which reduces the coefficient of friction and thus eases the donning of such gloves. U.S. Pat. No. 6,692,840 to Petrash et al. discloses the use of microspheres having diameters below 60 microns which reduce the friction, by decreasing the surface contact. Likewise, U.S. Pat. No. 6,638,587 to Wang et al. discloses embedding silicone resin particles in the donning coating. However, the problem with such coatings is the possibility of the hard particles separating from the donning coating and presenting the same issues as present with powdered lubricants as discussed above. The separation may occur if the particle is not properly adhered or may occur upon stretching and stressing of the glove in donning and in use.

Thus, there is a need for a donning coating for improved ease in donning of elastomeric articles even when the skin is damp or wet. It is desired that such a donning coating would be a single polymeric layer without the need for additional post-application treatments.

### SUMMARY OF THE INVENTION

The present invention is directed to an elastomeric article having a substrate body with a donning layer overlaying at least a portion of the surface of the substrate body. The donning layer is made of at least a first monomer and a second monomer that are copolymerized to make the first and second monomers incompatible with one another. In one embodiment the first monomer is hydrophilic, while the second monomer is hydrophobic. In further embodiments the first monomer may be hydroxy ethyl methacrylate, hydroxy ethyl acrylate, methacrylic acid, acrylic acid, vinyl pyrrolidone, acrylamide, dimethyl acrylamide, or any combination of such monomers. The second monomer may be 2-ethyl hexyl acrylate, methyl methacrylate, styrene, butyl acrylate, hydroxy propyl methacrylate, or any combination of such monomers. In yet another embodiment, polysiloxane polymeric material may be copolymerized with the first and second monomers to form the donning coating.

The invention is also directed to an elastomeric article having a substrate body that has a donning layer overlaying at least a portion of the substrate body's surface. The donning layer is a continuous polymeric layer having substantially discontinuous glassy domains separated by non-glassy domains.

Finally, the invention is directed to a method of forming an elastomeric article by forming a donning layer on an elastic substrate body. The donning layer may be made up of a first monomer and a second monomer which are copolymerized to make the first and second monomers incompatible with one another. When the coated substrate body is dried, the first and second monomers of the donning layer phase separate from one another, providing the donning layer with a hard and textured surface.

### BRIEF DESCRIPTION OF THE DRAWINGS

FIG. 1 is a perspective view of an elastomeric article, namely a glove, according to the present invention; and

FIG. 2 is a schematic cross-sectional illustration of another article made according to the present invention, the article including a substrate body and a donning layer.

### DETAILED DESCRIPTION

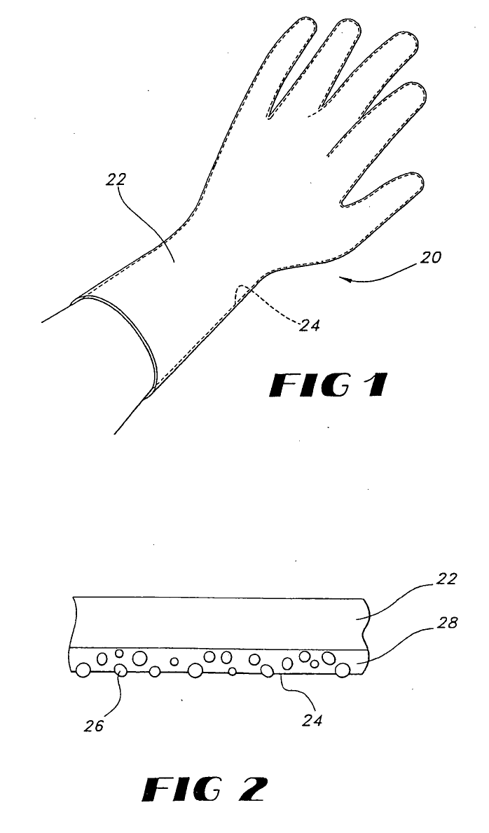

In general, the present invention is directed to an elastomeric article, such as a condom or glove, with a donning layer which is hard and textured thus improving the ease of donning such an article. The hardness of the donning layer decreases the coefficient of friction of the layer against the skin of the user. The texture reduces the surface area of the donning layer that will come in contact with the user. Both the hardness and the texture combine to improve the ease of donning such an article. While this invention pertains to polymeric coatings for all elastomeric articles, it will focus on the coating of gloves, such as the one shown in FIG. 1, which are the most complex of elastomeric articles in terms of use and manufacture.

The type of surface is produced by appropriately selecting the monomers that make up the polymeric donning layer of the elastomeric article. The monomers are selected and copolymerized on the elastomeric article in such a way as to make the monomers incompatible with one another in the donning layer's dried form. The donning layer 28 (FIG. 2) is applied to the substrate body 22 and the entire glove 20 is dried. When the inventive donning layer 28 dries, the blocks of incompatible monomer will phase out; separating to form domains of like monomer. As used here, the term “incompatible” refers to substances of the same phase (e.g., liquid) that cannot be uniformly mixed or blended without the use of a processing aid and will separate into distinct regions or domains once such a processing aid is removed. This will produce an overall donning layer surface that is textured due to the shrinkage caused by the incompatible monomers phasing out into the separate domains. This shrinkage-induced texturing will reduce the surface area that comes in contact with the skin of the user of the elastomeric article, thus aiding the ability to don the article over either damp or dry skin.

The donning layer 28 would be applied to the substrate body 22 in manner as known to those of ordinary skill in the art. Although other processes are available, generally speaking, the donning layer 28 would be applied by immersing the substrate body 22 in a dipping tank containing a solution of the donning layer material. The solution would include monomers that form the copolymer donning layer and any polymerization aids. The incompatible monomers are maintained in solution with one another by one or more processing aids. Such processing aids may be substances compatible with each monomer (i.e., a compatilizer) that holds the monomers in solution with one another, as well as with the other components of the solution, and is later removed upon formation of the copolymer. Alternatively, or in addition to a compatilizer, the processing aid may be the addition of heat and/or agitation to the solution.

The copolymerization of the incompatible monomers would occur on the substrate body 22 by an appropriate polymerization mechanism. While other polymerization mechanisms are possible and are included in the scope of this invention, a free-radical polymerization mechanism is generally thought to be well suited for the copolymerization of the incompatible monomers considered for the present invention. Free-radical polymerization requires that a free-radical initiator be present in the donning layer solution. The free-radical initiator has to be activated to initiate the polymerization of the monomers on the surface of the substrate body 22. Such activation is typically accomplished through thermal processes (heat) or by photo-chemical processes (UV light) depending on the free-radical initiator used. Organic peroxides are a commonly used free-radical initiator.

The monomers selected for the donning layer 28 copolymer would have to be capable of being polymerized into a single copolymer, but be incompatible with each other in the final copolymer form. One factor that goes to accomplish this goal is having monomers of a size large enough that the monomers cannot remain in proximity to one another in the final copolymer. Typically, it is generally thought that the monomers would have to have a molecular weight above 1000 g/mole. It is generally thought that a monomer molecular weight between about 10,000 and about 100,000 g/mole would be desired.

The desired type of surface could be the result of selecting a first monomer that is hydrophilic and a second monomer that is hydrophobic and copolymerizing the monomers in such a way that they compatible in solution, but incompatible once dried.

Examples of hydrophilic monomers to form the polymeric donning layer include, among others, hydroxy ethyl methacrylate, hydroxy ethyl acrylate, methacrylic acid, acrylic acid, vinyl pyrrolidone, acrylamide, dimethyl acrylamide, and similar monomers. Examples of possible hydrophobic monomers include, among other, 2-ethyl hexyl acrylate, methyl methacrylate, styrene, butyl acrylate, hydroxy propyl methacrylate, and such monomers. It may also be possible to copolymerize more than two monomers to achieve the incompatibility desired by this invention. In any case, an appropriate solvent so that the polymer coating can be applied as a solution, but the monomers will phase separate upon drying.

Some of the monomers listed above are the same types of monomers used in the formation of the hydrogel donning coatings as known to those of ordinary skill in the art. Such hydrogel donning layers help improve donning and the comfort of the glove by absorbing moisture that may be encountered at the surface of such a donning layer. Such hydrogel layers as known to those of ordinary skill in the art, however, are produced by copolymerizing such monomers in such a way as to make them compatible with one another. In the present invention, such monomers are specifically selected such that the monomers are incompatible in the resulting copolymer.

The donning layer can be further enhanced by selecting monomers that will result in a hard, as well as textured, surface upon drying of the donning layer. Such a hard surface will have a decreased coefficient of friction and would allow a product having such a layer to easily pass over the skin of the user. Incompatible monomers could be selected based on their relative glass transition temperatures. The “glass transition temperature” is the temperature at which an amorphous material changes from a brittle, vitreous state to a plastic state.

A “hard” monomer would have glass transition temperatures well above ambient temperature (i.e., around 23 degrees Celsius). Such a “hard” monomer would be glassy (i.e., brittle & hard, like glass) at such ambient temperatures. In general, “hard” monomers have a glass transition temperature above 50 degrees Celsius. Monomers with glass transition temperatures greater than other monomers would be considered to be “harder” than a monomer with a lower glass transition temperature. An example of a “hard” monomer is methyl methacrylate, which has a glass transition temperature above 100 degrees Celsius and thus has glassy characteristics at ambient temperatures, i.e., the normal temperature range of use. In contrast, a “soft” monomer would be one that has a glass transition temperature below, or near, ambient temperature. Such “soft” monomer would be non-glassy (i.e., soft and flexible) around ambient temperatures. For example, silicones have glass transition temperatures below ambient temperatures and thus are soft and flexible at ambient temperatures. Relative to other monomers, a monomer that is considered to be “softer” would the monomer with the lower glass transition temperature.

If a “hard” monomer is selected and used with an incompatible copolymer with a lower glass transition temperature monomer, the resulting dried donning layer 28 would have glassy, hard domains 26 as “islands-in-a-sea” of non-glassy domains. Such a hard surface would reduce the coefficient of friction of such a surface and would, in combination with the texture given to the surface by the incompatibility of the monomers, ease the donning of such an elastomeric article.

The incompatible domains that form within the donning layer 28 could be various sizes. The domains may be on the “micro” order of magnitude in the range of 0.01 micron to 1 micron. The domains may be on the “macro” order of magnitude in the range of 1 micron to 10 microns. However, these ranges are only exemplary and are not intended to be limiting. The size of the incompatible domains may be larger or smaller than the ranges given here. Additionally, the incompatible domains could be of equal size, either type of domains may be generally larger or smaller than a particular domain's incompatible counterpart, or all of the domains may be random in size.

By selecting monomers that are incompatible in copolymer form, and where one of the monomers selected is “hard,” the resulting surface should be both hard and textured. Such a donning layer 28 will have both a reduced surface contact area and a reduced coefficient of friction. Together, these factors would produce a donning layer 28 that increases the ease of donning such an article and would further provide such a surface without additional chlorination or lubrication processes.

Additionally, rather than adding a lubricant in a post-treatment process, polysiloxane groups may also be copolymerized with the first and second monomers. Such groups would aid in the donning of the elastomeric article over damp skin. Copolymerizing such groups into the polymeric donning layer would chemically bind them into the structure and prevent them from being washed away. Such lubricants are currently applied in liquid form to the donning side of the glove to aid in inserting damp hands into the glove. The ability to chemically bond the siloxane into the coating formulation would prevent it from being removed from the glove during subsequent operations in the manufacturing process or upon the removal of the glove from the hand. Additionally, adding the polysiloxane to the donning coating layer would reduce the number of process steps in the production of such a glove.

The substrate body may be formed from any suitable elastomeric polymer, and in some embodiments the substrate body may be formed from natural rubber, which is typically provided as a compounded natural rubber latex. In other embodiments, the elastomeric polymer may include nitrile butadiene rubber, and in particular, may include carboxylated nitrile butadiene rubber. In yet other embodiments, the elastomeric polymer may include synthetic isoprene. Styrene-isoprene-styrene (S-I-S) block copolymers, styrene-polybutadiene block copolymers (S-B), styrene-polybutadiene-styrene (S-B-S) block copolymers, styrene-ethylene-butylene-styrene block copolymers (S-EB-S), and mixtures thereof can form the basis for the substrate body. While articles formed from natural rubber are described in detail herein, it should be understood that any other suitable polymer or combination of polymers may be used with the present invention.

Thus, the polymer composition may contain various additives conventionally used with such elastomeric polymer systems. For example, natural rubber latex systems commonly utilize stabilizers, antioxidants, curing activators, organic accelerators, vulcanizers, and the like. The accelerator and vulcanizer contained in the latex coating are used to crosslink natural rubber. The vulcanizer forms sulfur bridges between different rubber segments and the accelerator is used to promote rapid sulfur bridge formation. The vulcanizer may be sulfur or a sulfur-containing compound. The organic accelerator may be dithiocarbamate. The stabilizers may include phosphate-type surfactants. The antioxidants may be phenolic, for example, 2,2′-methylenebis (4-methyl-6-t-butylphenol). The curing activator may be zinc oxide. To avoid crumb formation, the stabilizer, antioxidant, activator, accelerator, and vulcanizer may first be dispersed into water by using a ball mill and then combined with the natural rubber latex.

An elastomeric article of the present invention may be formed using any variety of conventional manufacturing processes for such an article. For example, the formation of a natural rubber article may use such processes as dipping, spraying, drying, and curing. An is exemplary dipping process for forming a glove 20 made of a natural rubber substrate is described herein, though other processes may be employed to form various articles having different shapes and characteristics. Although a batch process is described and shown herein, it should be understood that semi-batch and continuous processes may also be utilized with the present invention.

A glove 20 is formed on a hand-shaped mold, termed a “former”. The former may be made from any suitable material, such as ceramic, glass, metal, porcelain, or the like. The surface of the former defines at least a portion of the surface of the glove 20 to be manufactured.

If desired, a former may be cleaned prior to formation of a glove 20 on the former. The cleaning process may generally include an optional water pre-rinse followed by an acid wash. After the acid wash, the former may be rinsed with water and dipped in a heated caustic solution prior to a final water rinse. After the cleaning process, a glove may be formed on the former through a series of dipping and drying steps.

After cleaning, the former may be dipped into a coagulant composition prior to forming the main body of the glove 20 on the former. In the case of latex gloves, for example, a coagulant causes the base latex polymer that forms the main body of the glove 20 to coagulate. Coagulants that may be used in the present invention may include powders (e.g., calcium carbonate), to ease stripping of the glove from the former, or, if desired, may be powder free coagulant compositions. For example, a powder free coagulant composition may be used which includes water soluble salts of calcium, zinc, aluminum, and the like. Optionally, the coagulant composition may contain additives such as surfactants. A surfactant may provide enhanced wetting to avoid forming a meniscus that can trap air between the form and the deposited elastomeric polymer, particularly in the cuff area. However, any suitable coagulant composition may be used, including those described in U.S. Pat. No. 4,310,928 to Joung, incorporated herein in its entirety by reference.

The coated former is then dipped into a polymer composition containing an elastomeric polymer to form the substrate body 22 (FIGS. 1 and 2). During the dipping process, the coagulant on the former causes some of the elastomer to become locally unstable and coagulate onto the surface of the former. The elastomer coalesces, capturing the particles present in the coagulant composition at the surface of the coagulating elastomer. The former is withdrawn from the bath of elastomer and the coagulated layer is permitted to fully coalesce, thereby forming a substrate body 22. The former is dipped into one or more polymer baths a sufficient number of times to attain the desired glove 20 thickness. In some embodiments, the substrate body 22 may have a thickness of from about 0.004 inches to about 0.012 inches.

The former is then dipped into hot water, which is circulated in a leaching tank, to remove the water-soluble components, such as for example, residual calcium nitrates and proteins contained in natural rubber latex. This leaching process may generally continue for a period of time sufficient to remove a majority of the water soluble components, for example, about twelve minutes at a water temperature of about 120° F. The glove 20 is then dried on the former to solidify and stabilize the substrate body 22. It should be understood that various conditions, process, and materials used to form the substrate body 22.

Other layers may be formed by including additional dipping processes. Such layers may be used to impart additional attributes to the glove 20. When these processes are complete, the former then undergoes an additional coating process to form the interior, or donning layer 28, of the glove 20. It should be understood that any process may be used to form the donning layer 28, such as dipping, spraying, immersion, printing, tumbling or any other suitable technique.

When the former is withdrawn from the composition, the substrate body 22 coated with the donning layer composition is then sent to a curing station where the natural rubber is vulcanized, typically in an oven. The curing station initially evaporates any water remaining in the coating on the former and then proceeds to a higher temperature vulcanization. The drying may occur at a temperature of from about 85° C. to about 95° C., with a vulcanization step occurring at a temperature of from about 110° C. to about 120° C. For example, the glove 20 may be vulcanized in a single oven at a temperature of 115° C. for about 20 minutes. Alternatively, the oven may be divided into four different zones with a former being conveyed through zones of increasing temperature. For instance, the oven may have four zones with the first two zones being dedicated to drying and the second two zones being primarily for vulcanizing. Each of the zones may have a slightly higher temperature, for example, the first zone at about 80° C., the second zone at about 95° C., a third zone at about 105° C., and a final zone at about 115° C. The residence time of the former within each zone may be about ten minutes.

Upon being cured, the former may be transferred to a stripping station where the glove is removed from the former. The stripping station may involve automatic or manual removal of the glove 20 from the former. For example, in one embodiment, the glove 20 is manually removed and turned inside out as it is stripped from the former. By inverting the glove 20 in this manner, the textured donning layer 28 formed on the outside of the substrate is body 22 becomes the inside of the glove 20.

Elastomeric article made from elastic substrate materials other than natural rubber are made by similar methods as are known to those of ordinary skill in the art. For example, a process for making articles from styrene-ethylene-butylene-styrene block copolymers can be found in U.S. Pat. No. 5,900,452, U.S. Pat. No. 6,288,150, and U.S. Pat. No. 6,414,083, all to Plamthottam.

An elastomeric article could be formed by any of the above described conventional methods and a donning layer of the present invention containing incompatible monomers can be formed on such an article as described herein. Such a donning layer would provide a hard and textured surface to the elastomeric article and would give the article an improved ease of donning without the need of any additional post-application treatments.

We claim

1. An elastomeric article comprising:
a substrate body comprising an elastomeric material, the substrate body having a first surface; and
a donning layer overlaying at least a portion of the first surface, where the donning layer is comprised of a polymeric material made up of at least a first monomer and a second monomer which are copolymerized as to make the first and second monomers incompatible with one another.

2. The article of claim 1, where the first monomer is hydrophilic and the second monomer is hydrophobic.

3. The article of claim 2, where the first monomer is selected from the group consisting of hydroxy ethyl methacrylate, hydroxy ethyl acrylate, methacrylic acid, acrylic acid, vinyl pyrrolidone, acrylamide, dimethyl acrylamide, or combinations thereof.

4. The article of claim 2, where the second monomer is selected from the group consisting of 2-ethyl hexyl acrylate, methyl methacrylate, styrene, butyl acrylate, hydroxy propyl methacrylate, or combinations thereof.

5. The article of claim 2, where the donning layer further comprises a polysiloxane polymeric material copolymerized with the first and second monomers.

6. The article of claim 1, where the elastomeric material comprises natural rubber.

7. The article of claim 1, where the elastomeric material comprises a nitrile butadiene rubber.

8. The article of claim 1 where the elastomeric material comprises a styrene-ethylene-butylene-styrene block copolymer.

9. The article of claim 1, wherein the elastomeric material is selected from the group consisting of a styrene-isoprene-styrene block copolymer, styrene-butadiene-styrene block copolymer, styrene-isoprene block copolymer, styrene-butadiene block copolymer, synthetic isoprene, chloroprene rubber, polyvinyl chloride, silicone rubber, and a combination thereof.

10. The article of claim 1, where the article is a glove.

11. An elastomeric article comprising:
a substrate body comprising an elastomeric material, the substrate body having a first surface; and
a donning layer overlaying at least a portion of the first surface, where the donning layer is comprised of a polymeric material having substantially discontinuous glassy domains separated by a non-glassy domain.

12. A method for forming an elastomeric article comprising:
(a) preparing a substrate body comprising an elastomeric material, the substrate body having a first surface;
(b) forming a donning layer over at least a portion of the first surface, where the donning layer comprises a polymeric material made up of at least a first monomer and a second monomer which are copolymerized as to make the first and second monomers incompatible with one another; and
(c) drying the donning layer such that the incompatible first and second monomers phase separate and the donning layer forms a hard, textured surface.

13. The method of claim 12, where the first monomer is hydrophilic and the second monomer is hydrophobic.

14. The method of claim 13, where the first monomer is selected from the group consisting of hydroxy ethyl methacrylate, hydroxy ethyl acrylate, methacrylic acid, acrylic acid, vinyl pyrrolidone, acrylamide, and dimethyl acrylamide.

15. The method of claim 13, where the second monomer is selected from the group consisting of 2-ethyl hexyl acrylate, methyl methacrylate, styrene, butyl acrylate, and hydroxy propyl methacrylate.

16. The method of claim 13, where the donning layer further comprises a polysiloxane polymeric material copolymerized with the first and second monomers.

17. The method of claim 12, where the elastomeric material comprises natural rubber.

18. The method of claim 12, where the elastomeric material comprises a nitrile butadiene rubber.

19. The method of claim 12, where the elastomeric material comprises a styrene-ethylene-butylene-styrene block copolymer.

20. The method of claim 12, wherein the elastomeric material is selected from the group consisting of a styrene-isoprene-styrene block copolymer, styrene-butadiene-styrene block copolymer, styrene-isoprene block copolymer, styrene-butadiene block copolymer, synthetic isoprene, chloroprene rubber, polyvinyl chloride, silicone rubber, and a combination thereof.
